(19) United States
(12) Patent Application Publication
(10) Pub. No.: US 2009/0138554 A1
(43) Pub. Date: May 28, 2009

(54) Controlling virtual meetings with a feedback history

(76) Inventors: Giuseppe Longobardi, C/mare di Stabia (NA) (IT); Scot MacLellan, Roma (IT)

Correspondence Address: Law Offices of Michael Dryja (Austin), 1474 N. COOPER RD #105-248, GILBERT, AZ, 85233, US

(21) Appl. No.: 12/277,157

(22) Filed: Nov. 24, 2008

(30) Foreign Application Priority Data
Nov. 26, 2007 (EP) 07121495.1

(51) Int. Cl. G06F 15/16

(52) U.S. Cl. 709/204

(57) ABSTRACT

Information is transmitted from at least one source entity to target entities over a working session, and is output on each target entity to a corresponding user. A feedback indicator is provided on each target entity. The feedback indicator is indicative of a personal level of interest of the corresponding user for the information at each instant within the session. The feedback indicator is returned from each target entity to a control entity. The feedback indicators are aggregated on the control entity into at least one aggregated indicator, which is indicative of an overall level of interest of the users for the information at each instant within the session. A representation of a history of the session of the at least one aggregated indicator is at least partially output on the control entity to a controller for controlling a virtual meeting according to the history.

### RELATED APPLICATIONS

The present patent application claims priority under 35 USC 119 to the previously filed European (EP) patent application filed on Nov. 26, 2007, and assigned application no. 07121495.1.

### FIELD OF THE INVENTION

The present invention relates generally to the information technology field, and more specifically relates to delivering information via data processing systems having distributed architectures.

### BACKGROUND OF THE INVENTION

This disclosure relates to applications for delivering information on data processing systems having distributed architectures. In particular, the large bandwidth made available by modern communication channels has fostered the relatively widespread usage of applications that permit delivery of multimedia content to remote users. For example, applications implementing virtual meetings are commonly used to share multimedia content in a synchronous manner, meaning that the process is perceived by the users to occur in real-time.

Generally, virtual meetings are mostly one-way. One or more users, who are referred to as presenters, deliver content to other users, who are referred to as participants. The participants are commonly permitted to intervene within the virtual meetings by submitting specific requests to the presenters. For example, in virtual conferences a single presenter directly controls the delivery of the content to the participants, and thus also acts as a controller. Conversely, in virtual seminars multiple presenters deliver content in sequence, under the control of another user, who is the controller, and who acts as a moderator. The content is transmitted among the users over any type of transmission mechanism, such as cables, digital or analog wireless signals, and the like. In the case of the Internet, the virtual meetings are also referred to as web meetings, and more particularly are referred to as web conferences or web seminars, the latter which are commonly referred to as webinars.

Such virtual meetings provide a time and cost effective alternative to traditional face-to-face meetings, which often require travel by the presenters and the participants to meet at a common physical site.

### SUMMARY OF THE INVENTION

The present invention relates to controlling virtual meetings using a feedback history. A method according to one embodiment of the invention is for delivering information in a virtual meeting on a data processing system having a distributed architecture. The method transmits information from at least one source entity of the system to target entities of the system over a working session. The method outputs the information on each target entity to a corresponding user. The method provides a feedback indicator on each target entity. The feedback indicator is indicative of a personal level of interest of the corresponding user for the information at each instant within the session.

The method further returns the feedback indicator from each target entity to a control entity of the system. The method aggregates the feedback indicators on the control entity into at least one aggregated indicator. The aggregated indicator is indicative of an overall level of interest of the users for the information at each instant within the session. The method outputs at least partially a representation of a history of the session of the at least one aggregated indicator on the control entity to a controller of the virtual meeting for controlling the virtual meeting according to the history.

A computer-readable medium of one embodiment of the invention has a computer program stored thereon. The computer-readable medium may be a recordable data storage medium, or another type of tangible computer-readable medium. The computer program, when executed on a data processing system having a distributed architecture, causes the data processing system to perform a method for delivering information in a virtual meeting on the data processing system. This method can be the method that has been described in the previous paragraphs.

A virtual meeting system of one embodiment of the invention is for delivering information in a virtual meeting on a data processing system with distributed architecture. The virtual meeting system includes a first interface to transmit information from at least one source computer of the system to target computers of the system over a working session. The first interface can be considered as the means that performs the functionality ascribed to the first interface. The virtual meeting system includes a first output driver to output the information on each target computer to a corresponding user. The first output driver can be considered as the means that performs the functionality ascribed to the first output driver.

The virtual meeting system also includes an interest engine to provide a feedback indicator on each target computer. The interest engine can be considered as the means that performs the functionality ascribed to the interest engine. The feedback indicator is indicative of a personal level of interest of the corresponding user for the information at each instant within the session. The virtual meeting system includes a second interface to return the feedback indicator from each target computer to a control computer of the system. The second interface can be considered as the means that performs the functionality ascribed to the second interface.

The virtual meeting system further includes an evaluator to aggregate the feedback indicators on the control computer into at least one aggregated indicator. The evaluator can be considered as the means that performs the functionality ascribed to the evaluator. The aggregated indicator is indicative of an overall level of interest of the users for the information at each instant within the session. The virtual meeting system includes a second output driver to output at least partially a representation of a history of the session of the at least one aggregated indicator on the control computer to a controller of the virtual meeting for controlling the virtual meeting according to the history. The second output driver can be considered as the means that performs the functionality ascribed to the evaluator.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a schematic block diagram of a data processing system, in relation to which an embodiment of the invention may be practiced.

FIG. 2 is a diagram of an exemplary computer of a system, according to an embodiment of the invention.

FIGS. 3-6 are diagrams depict different examples, according to varying embodiments of the invention.

FIG. 7 is a collaboration diagram representing the roles of different components that can be used, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

An embodiment of the invention collects and aggregates feedback continuously. More specifically, in one embodiment of the invention, information is delivered in a virtual meeting on a data processing system having a distributed architecture. Information, such as multimedia content, is transmitted from at least one source entity of the system, which may be assigned to a presenter of a web meeting, to target entities of the system, which may be assigned to participants of the web meeting, over a working session. The information is output on each target entity to a corresponding user. A feedback indicator is then provided on each target entity, either manually or automatically. The feedback indicator is indicative of a personal level of interest of the corresponding user for the information at each instant along the session.

The feedback indicator is returned, such as via a chat channel, from each target entity to a control entity of the system, which may be assigned to a controller of the web meeting, and who may possibly be also acting as a presenter. The feedback indicators are aggregated on the control entity into at least one aggregated indicator, such as their average value. The aggregated indicator is indicative of an overall level of interest of the users for the information at each instant within the session. A representation of the history of the session of the aggregated indicator, or a part thereof, is then output on the control entity to a controller of the virtual meeting, for controlling the virtual meeting according to the history.

In one embodiment of the invention, the feedback indicator is estimated automatically according to an interaction of the user with the target entity. In another embodiment, the feedback indicator is set manually by the user, who is also prompted to do so after a predefined time-out from a last setting. In this case, it is also possible to reset the feedback indicator to a neutral value at the start of each topic of the session. In one embodiment, the feedback indicator is returned to the control entity in a service message with a specific format, so as to allow discriminating it from standard messages to be forwarded to the other client entities. In one embodiment, the most recent portion of the history is displayed in real-time, or with a short delay, for controlling the session.

Furthermore, a warning condition can be signaled to the controller when the aggregated indicator substantially passes a threshold value for a threshold time. In one embodiment, a feature of the system provides for the transmission of the aggregated indicator to each target entity as well. Additionally, the complete history can be logged and used off-line to control the next session of the virtual meeting. One embodiment of the invention may be used in relation to a virtual conference, in which the control entity is the (single) source entity. Another embodiment of the invention may be used in relation to a virtual seminar, in which multiple presenters on the source entities transmit information under the control of a control entity, and where an aggregated indicator is associated at each instant with a corresponding presenter.

### Detailed Embodiment

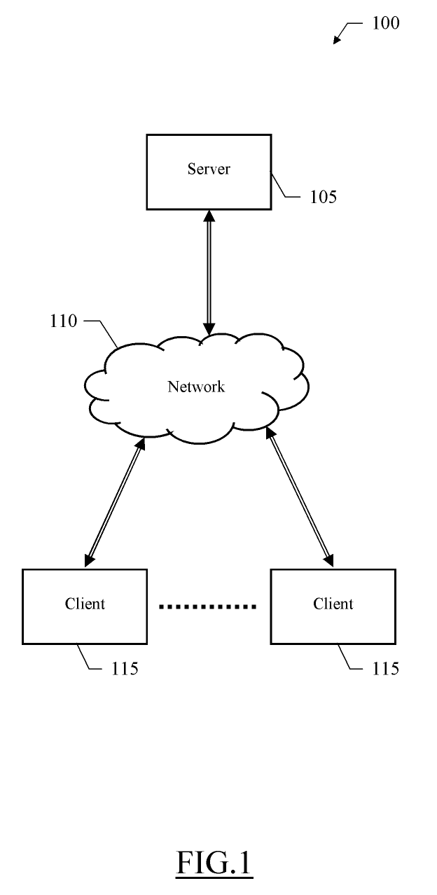

FIG. 1 shows a data processing system 100 having a distributed architecture, according to an embodiment of the invention. The system 100 has a client/server structure, such as one based on the Internet, or any other type of network connection. The Internet includes a very large number of servers 105 (only one of which is depicted in FIG. 1), which are interconnected through a global communication network 110. Each server 105 offers one or more services. Users of clients 115 access the server 105 through computers, which are not shown in FIG. 1, and which operate as access providers for the Internet, in order to use the offered service.

The server 105 provides a web meeting service, which supports a number of working sessions of a web meeting. Each working session permits the users of a set of clients 115 to share multimedia contents in a synchronous manner. For this purpose, one or more users, or presenters, transmit content from their presenter clients 115 to the server 105, or act directly from the server 105. The server 105 delivers the content to other users, or participants, by broadcasting the clients to the participant clients 115. For example, the content may include images, video, voice, text, and the like. The content that is provided during each session of the web meeting is typically organized into different topics, such as the main aspects of a project to be presented. The participants may also submit requests to the current presenter, such as questions in the form of text messages. The session is controlled by a special user, the controller, who sends corresponding commands from his or her controller client 115 to the server 105, or the controller acts directly from the server 105. In a web conference with a single presenter the controller typically is the same user as the same presenter, whereas in a web seminar with multiple presenters the controller is typically distinct user other than a presenter.

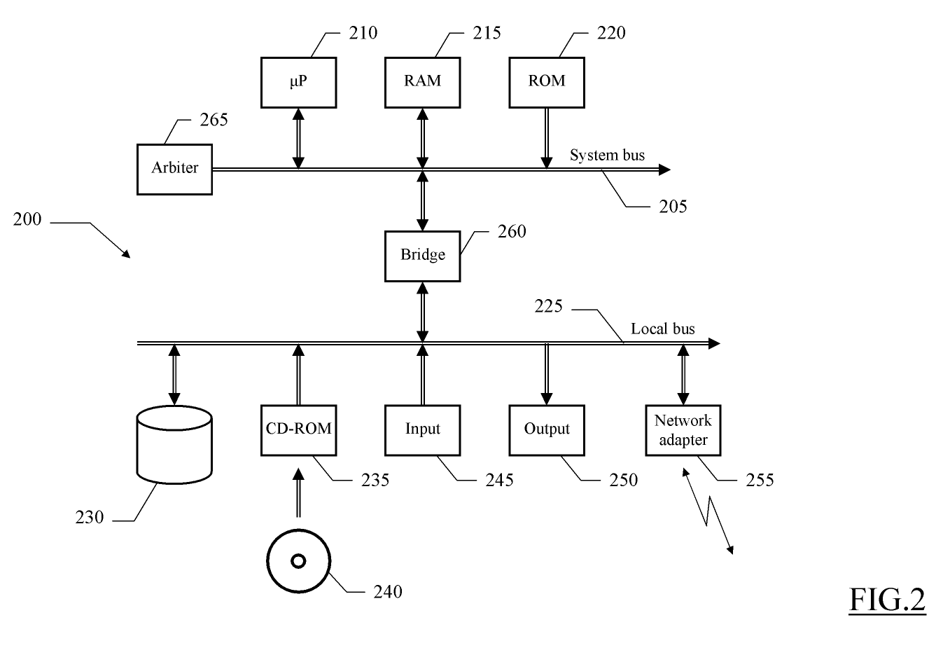

FIG. 2 shows a generic computer 200 of the above-described system (server or client), according to an embodiment of the invention. The computer 200 is formed by several units that are connected in parallel to a system bus 205, via a structure that is suitably scaled according to the actual function of the computer 200 in the system. In detail, one or more microprocessors 210 control operation of the computer 200. A random-access memory (RAM) 215 is directly used as a working memory by the microprocessors 210, and a read-only memory (ROM) 220 stores basic code for a bootstrap of the computer 200.

Several peripheral units are clustered around a local bus 225, via respective interfaces. Particularly, a mass memory includes one or more hard disks 230 and drives 235 for reading compact-disc ROMs (CD-ROMs) and/or digital-versatile disc ROMs (DVD-ROMs) 240. Moreover, the computer 200 includes input units 245, such as a keyboard, a mouse, a web cam, and a microphone, and output units 250, such as a monitor, headphones and loudspeakers. An adapter 255 is used to connect the computer 200 to the network. A bridge unit 260 interfaces the system bus 205 with the local bus 225. Each microprocessor 210 and the bridge unit 260 can operate as master agents requesting access to the system bus 205 for transmitting information. An arbiter 265 manages the granting of the access with mutual exclusion to the system bus 205.

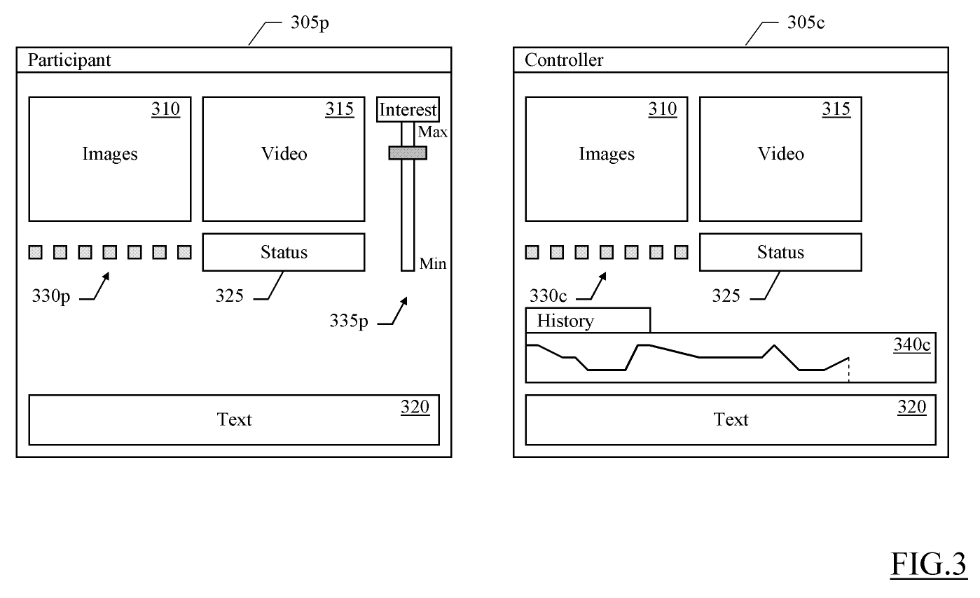

FIG. 3 shows a graphical user interface (GUI) of a client, according to an embodiment of the invention. The GUI configures a screen of the corresponding monitor as a desktop. Particularly, the web meeting involves the displaying of a participant window 305p in the desktop of each participant client. The participant window 305p includes a frame 310 for showing images, such as slides provided by the presenter. Another frame 315 is used to playback a video, which may be provided by the presenter or another participant via a corresponding web cam. A further frame 320 is used to display a text message for a request that has been submitted by one of the participants.

A box 325 is used to show a current status of the connection of the participant client to the server, where the status may be active or inactive. The participant window 305p also includes a set of participant commands 330p, such as menu voices, buttons, and the like. The participant commands 330p are used by the participant to handle his/her attendance to the session, such as start, pause, resume, and stop, as well as to set a personal configuration of the session, such as enabling or disabling the corresponding web cam, controlling a voice volume, and the like. Moreover, the participant commands 330p are used by the participant to submit corresponding requests of intervention into the session, such as by selecting a “hand up” command for requesting permission to pose a question. A window with similar content may also be displayed in the desktop of each presenter in a web seminar.

A web meeting involves the displaying of a controller window 305c in the desktop of the controller client. As above, the controller window 305c includes the frame 310 for showing the images, the frame 315 for playing back the video, the frame 320 for displaying the text messages, and the box 325 for showing the current status of the connection of the controller client to the server. The controller window 305c also includes a set of controller commands 330c, such as menu choices, buttons, and the like. The controller commands 330c are used by the controller to handle the session, such as to start and stop the session, and to accept, invite or eject presenters and/or participants, to grant permissions to the participants for submitting questions, to enable a current presenter in a web seminar, and so on.

In one embodiment of the present invention, each participant provides a feedback indicator, either manually or automatically. The feedback indicator represents a personal level of interest of the participant for the contents that are delivered at each instant along the session. The feedback indicators of all the participants, or at least part of them, are collected on the controller client. These feedback indicators are then aggregated into at least one aggregated indicator, such as their average value. The aggregated indicator represents an overall level of interest of the users for the delivered contents at each instant along the session. A history of the aggregated indicator, or a portion thereof, is then used to control the virtual meeting accordingly, either in real-time or off-line.

The history of the aggregated indicator provides continuous information about the session at each instant within its whole duration, and not just punctual information at a specific instant or final information of the whole session. Moreover, the aggregated indicator allows obtaining the desired information in any situation. Particularly, this feature makes the proposed method insensitive to the number of participants that attend the web meeting and to their identification. This advantage can be clearly perceived in a webcast, although the use of an embodiment of the invention in other types of situations is not excluded. All of the above, therefore, facilitates the control of a web meeting, with a beneficial impact on its effectiveness.

In a specific embodiment of the invention, as shown in FIG. 3, the participant window 305p is provided with a slider 335p for setting the feedback indicator manually by the participant. For example, the slider 335p has a cursor that can be moved by the participant, such as with a mouse or other pointing device, between a minimum value and a maximum value and indicative of his or her interest in the delivered contents. The values in this range may be continuous or discrete, and they may be represented with a numerical scale or with descriptive phrases, such as very high, high, neutral, low, and very low. Typically, the feedback indicator is maintained at any given instant at its last value that has been selected within the session, until it is expressly changed by the participant. In this way, the participant can set the feedback indicator at any instant within the session in a very simple manner.

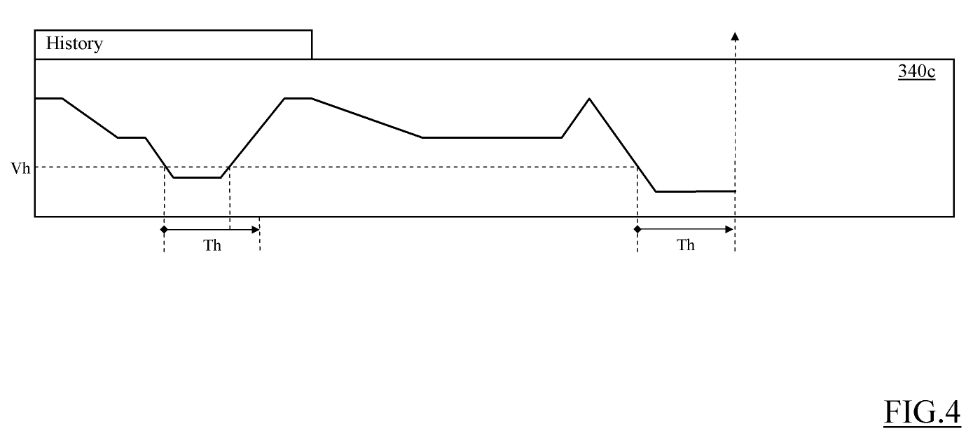

The controller window 305c includes a frame 340c, which shows a graph plotting the aggregated indicator as a function of time, and that is calculated by averaging the feedback indicators at any instant in one embodiment. The graph may show the most recent portion of the history of the aggregated indicator, such as its value along the last 30-60 minutes of the session, for example, with the ability of the controller to scroll the history of the aggregated indicator along the whole session. As such, the controller has an immediate view of the overall level of interest of all the participants over the session. The same frame may also be displayed in the desktop of each presenter in a web seminar, and may be displayed in the participant window 305p. The history of the aggregated indicator makes it possible to implement a number of sophisticated controls of the web meeting. Some examples, according to varying embodiments of the present invention, are illustrated in FIGS. 4-6.

In FIG. 4, when the frame 340c having the graph of the history of the aggregated indicator is displayed in real-time to the presenter, the presenter can decide how to proceed according to the overall interest being shown by the participants over the session. In this respect, it is emphasized that the decision can be based on the short history of the aggregated indicator, and not just on an instantaneous feedback that would only provide punctual or immediate information at a specific moment in time. For example, when the aggregated indicator decreases, corresponding to low overall interest, the presenter can move quickly to another topic. Conversely, when the aggregated indicator increases, corresponding to high overall interest), the presenter can spend more time on the current topic in question.

In one embodiment, a further improvement is to monitor the aggregated indicator along the session against a threshold value Vh indicative of a lower safe limit for the overall interest, such as 30%-50% of its maximum value. In this way, it is possible to detect a warning condition when the aggregated indicator falls below the threshold value Vh and it remains below it for a threshold period of time Th, such as 5-10 minutes. When this occurs, at the right end of the graph in FIG. 4, the warning condition is signaled to the presenter. For example, the graph may blink as indicated by the vertical arrow in FIG. 4. In addition, it is also possible to detect when the warning condition is exited, such that the aggregated indicator returns above the threshold value Vh), and to signal this occurrence to the presenter.

As such, any need for prompt intervention by the presenter to take corrective actions in an attempt to again earn the interest of the participants is detected automatically. Therefore, the presenter benefits from having the history of the aggregated indicator being available, while at the same time can remain focused on the session. It is noted that this feature also allows filtering out any transient decrease of the overall interest for a time shorter than the threshold period Th, such as at the beginning of the graph in FIG. 4. In this way, the presenter is informed only of the significant drops of the aggregated indicator that actually require his or her intervention.

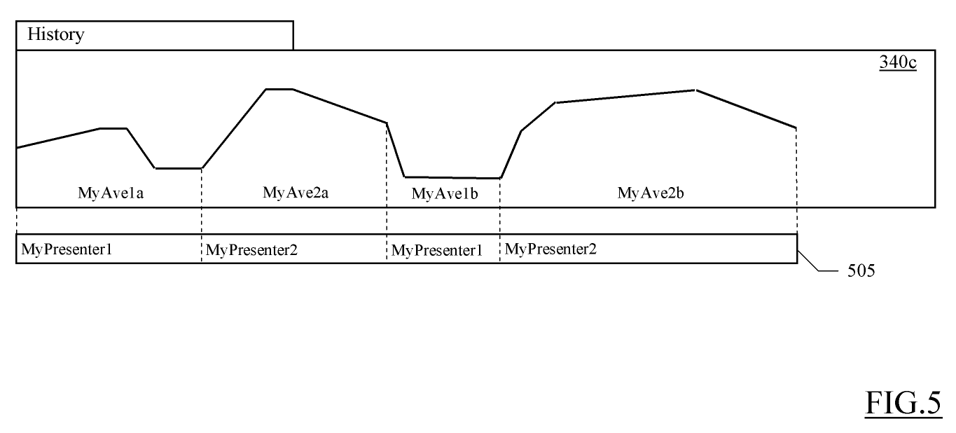

In FIG. 5, when the frame 340c is displayed in real-time to the controller in a web seminar having multiple presenters, the aggregated indicator over the session may be associated with the corresponding presenters that delivered the contents at any given time. The controller can then control the session according to the overall interest being shown by the participants for each presenter. For example, a bar 505 is provided below the frame 340c, which displays an identifier of each presenter for the corresponding portion of the session, such as MyPresenter1 and MyPresenter2 in the case at issue.

As a result, the controller has an immediate view of the overall interest for each presenter. To facilitate this operation, it is also possible to calculate and display an average value of the aggregated indicator along each portion of the session, such as MyAve1a and MyAve1b for the presenter MyPresenter1, and MyAve2a and MyAve2b for the presenter MyPresenter2. In this way, the controller is informed about which presenters are capturing the interest of the participants. Therefore, the controller can decide to dedicate more time to the presenter that is more effective, as is shown on the left of the graph in FIG. 5.

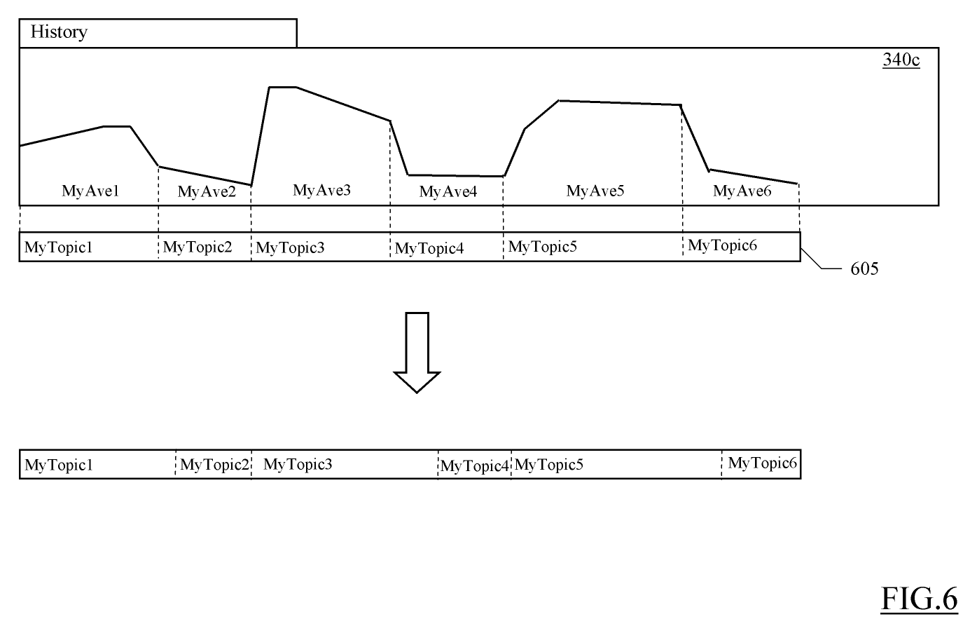

In FIG. 6, the whole history of the aggregated indicator is logged and analyzed off-line after completion of the session, so as to determine how to plan a next session of the same web meeting accordingly. In this respect, it is emphasized that the analysis is now based on the long history of the aggregated indicator along the whole session, and not only on a final feedback that would provide just general information about the entire session. For example, the aggregated indicator over the session may be associated with different topics, so as to plan a next session of the web meeting according to the overall interest being shown by the participants for each topic.

A bar 605 is again provided below the frame 340c, which displays an identifier of each topic for the corresponding portion of the session, such as MyTopic1-MyTopic6 in FIG. 6. This provides an immediate view of the overall interest for each topic of the session. As above, an average value of the aggregated indicator may be calculated and displayed along each portion of the session. In this way, it is possible to determine which topics were found more interesting by the participants, such the topics MyTopic3 and MyTopic5, followed by the topic MyTopic1 in this case. As such, an agenda of the web meeting for the next session may be adjusted by giving more room to these topics to the detriment of the other ones, as shown at the bottom of FIG. 6, in an attempt to maximize the succession of the next session of the web meeting.

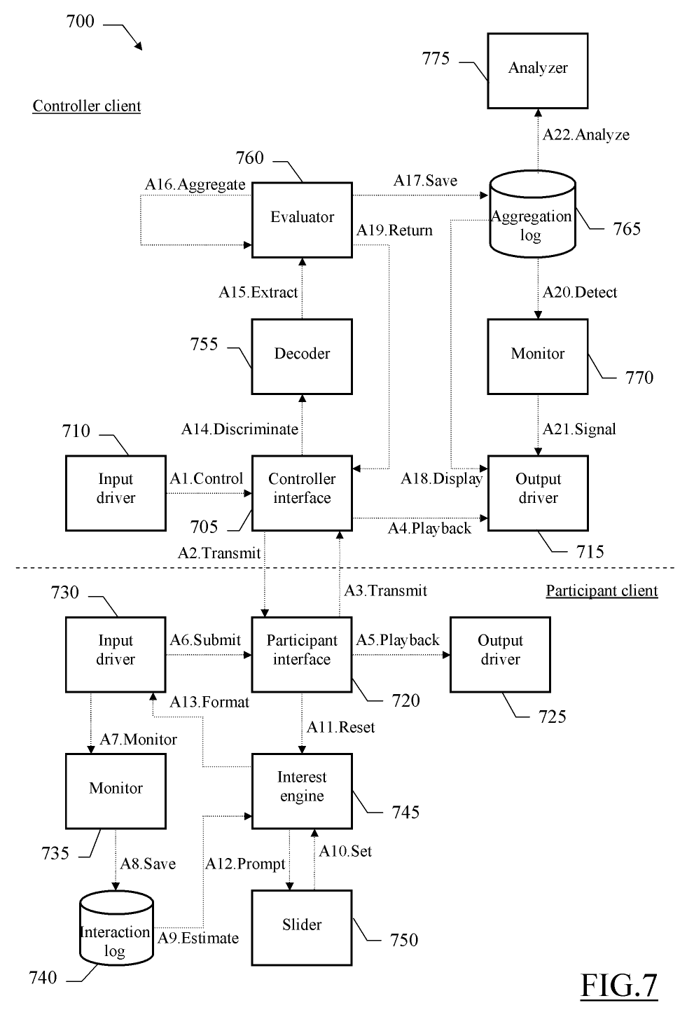

FIG. 7 shows the main components 700 that can be used to implement an embodiment of the invention. Information, including programs and data, is typically stored on a hard disk and at least partially loaded into the working memory of each computer when the programs are running, together with an operating system and other application programs, which are not depicted in FIG. 7. The programs may initially be installed onto the hard disk from CD-ROM, for example. FIG. 7 shows the static structure of the system, via its corresponding components, as well as its dynamic behavior, via a series of exchanged messages, where each such messages representing a corresponding action and is denoted with a sequence numbers preceded by the symbol “A”. The components 700 may each be implemented as or via software, hardware, or a combination of software and hardware.

A controller interface 705 handles the session of the web meeting on the controller client. The controller interface 705 may include either an application that is downloaded on the controller client or a web application that is accessed on the server through a browser that is not shown in FIG. 7. An input driver 710 is used by the controller to enter the desired commands into the controller interface 705 (action “A1.Control”).

In response thereto, the controller interface 705 sends corresponding information to the other clients through a server not shown in FIG. 7 (action “A2.Transmit”). The sent information includes the commands for handling the session and the content to be delivered, when the controller is also a presenter of a web conference. The controller interface 705 receives information from the other clients through the server (action “A3.Transmit”). The received information includes the requests being submitted by the participants and the content being delivered by the presenter, in the case of a web seminar. Typically, the different types of information are sent and received through corresponding communication channels, such as a streaming channel, a voice-over-Internet-protocol (VoIP) channel, a chat channel, and the like. The information so received is passed to an output driver 715 for its playback (action A4.Playback”).

Referring now to a generic participant client, a participant interface 720, which as noted above can include a downloaded application or a web application, controls the attendance to the session of the web meeting. The participant interface 720 receives the information transmitted by the other clients through the server (same action “A2.Transmit”). The received information includes the commands provided by the controller and the content delivered by the presenters. The information so received is passed to an output driver 725 for playback (action A5.Playback”). The participant interface 720 also sends information to the other clients through the server (same action “A3.Transmit”). The sent information includes the requests to be submitted to the controller and the presenters.

An input driver 730 is used by the participant to enter the desired requests for the participant interface 720. Once the participant has been duly authorized by the controller, he or she may also enter a text message to be sent to the presenter client through the chat channel (action “A6.Submit”). The feedback indicator may be set on the participant client either automatically or manually. In the former case, a monitor 735 measures an interaction of the participant with the virtual meeting along the session (action “A7.Monitor”). The monitor 735 detects relevant actions that are performed by the participant during the session, such as on the participant window. The monitor 735 saves the information so obtained into a corresponding log 740 (action A8.Save”). An interest engine 745 retrieves the information stored in the log 740, and uses it to estimate the feedback indicator (action “A9.Estimate”).

For example, the feedback indicator may be calculated in accordance with a delay, corresponding to the changing of slides that have been previously downloaded onto the participant client, and with respect to a corresponding change in topic by the presenter. In one embodiment, a reference value of the delay is determined during a start period of the session, such as the first 10-15 minutes of the session. Thereafter, the feedback indicator starting from a neutral value is increased or decreased when the frequency of the slide changes is higher or lower, respectively, than the reference value.

In an embodiment in which the feedback indicator is set manually, the participant may change the feedback indicator at any time by acting on the slider. A corresponding slider driver 750 decodes and normalizes the entered value, such as from 0 to 100, and provides it to the interest engine 745 (action “A10.Set”). In one embodiment, the participant interface 720 may also detect the start of a new topic along the session, such as by detecting a corresponding code included in the delivered contents. In response to such detection, the participant interface 720 may cause the interest engine 745 to reset the feedback indicator to a neutral value, so as to begin collecting a fresh value thereof (action “A11.Reset”).

The interest engine 745 may also monitor any express set of the feedback indicators by the participant. For example, whenever a predefined time-out expires from a last setting of the feedback indicator, such as 5-10 minutes, the interest engine 720 may prompts the participant to set it again, such as by using a pop-up window (action “A12.Prompt”). In this way, it is ensured that the participant is in fact tracking his or her level of interest along the session. Whenever the feedback indicator is changed, either automatically or manually, the interest engine 745 includes the feedback indicator into a service text message with a special format. For example, the service text message may enclose the feedback indicator between a specific trailing char and a specific leading char, such as §. The service text message is then passed to the input driver 730 (action “A13.Format”), for transmission to the controller client through the chat channel (same actions “A6;A2”). In this way, the transmission of the feedback indicator uses the chat channel that is already available in most web meetings.

Returning to the controller client, the controller interface 705 discriminates the service text message from the other text messages according to its format. The service text message is not sent to the other clients, but it is passed to a decoder 755 (action “A14.Discriminate”). The decoder 755 extracts the feedback indicator from the service text message, such as by removing the trailing and leading chars in the example at issue. The feedback indicator so obtained is then passed to an evaluator 760 (action “15.Extract”). The evaluator 760 aggregates the feedback indicators that are received from the different participant clients into the aggregated indicator, with each feedback indicator that maintains its last value until it is changed). For example, this result can be achieved by calculating the average value of the feedback indicators every 10-20 s (action “A16.Aggregate”).

The value so obtained is continuously saved into a corresponding log 765 (action “A17.Save”). The most recent portion of the history of the aggregated indicator is continuously extracted from the log 765 and passed to the output driver 715 for displaying on the controller window (action “A18.Display). In addition, the evaluator 760 may return the aggregated indicator just calculated to the controller interface 705 (action “A19.Return”). This causes the transmission of the aggregated indicator to the presenter clients in a web seminar and/or to the participant clients (same action “A2.Transmit”) for analogously displaying the most recent portion of its history. For example, this additional feature may be advantageously employed to publicize the popularity of the presenters, such as two contestants in a political debate.

A monitor 770 retrieves the aggregated indicator that is saved in the log 765 during the session. The monitor 770 can then detect any occurrence of the warning condition when the aggregated indicator remains below the threshold value for more than the threshold period (action “A20.Detect”). In response to such detection, the monitor 770 notifies the warning condition to the output driver 715 for its signaling to the controller (action “A21.Signal”). After completion of the session, the entire history of the aggregated indicator over the whole session may be extracted from the log 765 by an analyzer 775. The analyzer 775 uses the obtained information to control the next session of the same web meeting (action “A22.Analyze”). For example, the analyzer 775 may provide a box for displaying the history, and may provide commands for tuning the agenda of the next session of the web meeting.

### Conclusion

A person skilled in the art may apply to the embodiments of the invention described many logical and/or physical modifications and alterations. More specifically, although embodiments of the present invention have been described with a certain degree of particularity, it should be understood that various omissions, substitutions, and changes in the form and details, as well as other embodiments, are possible. Particularly, the proposed embodiments may be practiced without the specific details set forth in the preceding description to provide a more thorough understanding thereof It is intended that specific elements and/or method steps or parts described in connection with any disclosed embodiment of the invention may be incorporated in any other embodiment.

The embodiments of the invention that have been described lend themselves to be implemented with equivalent methods, by using similar steps or parts, by removing some steps or parts, and/or or adding further steps or parts. Furthermore, the steps or parts may be performed in a different order, concurrently, or in an interleaved manner at least in part. Similar considerations apply where the delivered content includes any other type of information, such as only images, video, voice, text, annotations on a white-board, screen/desktop/application sharing, or any combination thereof Likewise, the content may be transmitted in different ways, such as via dedicated unicast channels, telephone lines, e-mail, and the like.

Although in the preceding description reference has been made to web meetings, and in particular to web conferences and web seminars, this is not to be interpreted in a limiting manner. More generally, embodiments of the invention lend themselves to be applied to any equivalent virtual meeting in the broadest meaning of the term. Such virtual meetings can include virtual/electronic (e-)/distance presentations, lectures, interactive television transmissions, talk shows, workshops, classrooms, courses, tutorials, education sessions, and the like. Any equivalent interface may further be used for interacting with the web meeting, such as by outputting the delivered content only on the monitor, providing the voice over a telephone device, with different commands, etc.

The use of additional and/or different statistical values for the aggregated indicator, such as a maximum and minimum of the feedback indicators, is also within the scope of embodiments of the invention. It is further possible to provide any equivalent measure indicative of the personal and overall interest of the participants to the delivered content, including in this meaning their agreement, reaction, and the like. The aggregated indicator may be calculated with more sophisticated technique, such as by assigning different weights to special participants). It is also possible to output any representation of the history of the aggregated indicator, entirely or in part, on any equivalent control entity of the system. Such a control entity can include the controller client, the presenter clients, the participant clients, the server when also acting as a controller and/or presenter client, or any combination thereof.

It is also possible to evaluate the feedback indicator according to other parameters based on the interaction of the participant with the session, such as the number of submitted requests, and so on. Likewise, the feedback indicator may be set manually with buttons, hardware devices attached to the participant client, and the like. The feedback indictor may also be transmitted to the controller client periodically, and not just when it changes. The participant may be prompted to set the feedback indicator expressly after a different time-out. In another embodiment, it is possible to reset the feedback indicator to a different value at the start of every topic, or this operation may be performed just at the beginning of the whole session.

The service messages used to transmit the feedback indicators may have equivalent formats, such as, for example, by being identified according to a control code in their headers. However, the feedback indicators may be transmitted in other ways as well, such as via a dedicated channel. The aggregated indicator may be output in any equivalent form. For example, it is possible to use a histogram, specific icons, and the like. Similar considerations apply if different techniques are used for detecting the warning condition, such as by filtering out short peaks of the aggregated indicator, and/or for signaling the warning condition, such as with a buzzer. This feature may further be omitted altogether in a simplified implementation.

The logged history of the aggregated indicator may be used to perform any other off-line analyses of the web meeting, such as comparing the performance of different sessions thereof of the web meeting. As such, the above-described applications of the embodiments of the present invention are merely illustrative, and they are not to be interpreted in a limiting manner. For example, the history of the aggregated indicator may be used only in real-time, only off-line, in both modes at the same time, and so on. The proposed service may be implemented by any equivalent service provider, such as a cluster of servers. Embodiments of the invention may further be implemented within a non-service-based environment.

Similar considerations apply if the computer program that may be used to implement an embodiment of the invention is structured in a different way, or if additional modules or functions are provided. The memory structures may be of other types, or may be replaced with equivalent entities. The computer program may take any form suitable to be used by any data processing system or in connection therewith, such as within a virtual machine). The computer may be in the form of external or resident software, firmware, or microcode, either in object code or in source code, for example, to be compiled or interpreted).

Moreover, it is possible to provide the program on any computer-usable medium. The medium can be any element suitable to contain, store, communicate, propagate, or transfer the program. For example, the medium may be of the electronic, magnetic, optical, electromagnetic, infrared, or semiconductor type. Examples of such media include fixed disks where the program can be pre-loaded, removable disks, tapes, cards, wires, fibers, wireless connections, networks, broadcast waves, and the like. Embodiments of the present invention in general can be implemented using a hardware structure, such as integrated in a chip of semiconductor material), or using a combination of software and hardware.

Embodiments of the present invention may also be carried out on a system having a different architecture or including equivalent units, such as by being based on a local network. Moreover, each computer may have another structure or may include similar elements, such as cache memories temporarily storing the programs or parts thereof It is further possible to replace the computer with any code-execution entity, such as a personal digital assistance (PDA), a mobile phone device, and so on, or with a combination thereof Examples of the latter include multi-tier architectures, grid computing infrastructures, and so on.

It is therefore noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

What is claimed is:

1. A method for delivering information in a virtual meeting on a data processing system having a distributed architecture, the method comprising:
transmitting information from at least one source entity of the system to a plurality of target entities of the system over a working session;
outputting the information on each target entity to a corresponding user;
providing a feedback indicator on each target entity, the feedback indicator being indicative of a personal level of interest of the corresponding user for the information at each instant within the session;
returning the feedback indicator from each target entity to a control entity of the system;
aggregating the feedback indicators on the control entity into at least one aggregated indicator, the aggregated indicator being indicative of an overall level of interest of the users for the information at each instant within the session; and,
outputting at least partially a representation of a history of the session of the at least one aggregated indicator on the control entity to a controller of the virtual meeting for controlling the virtual meeting according to the history.

2. The method of claim 1, wherein providing the feedback indicator on each target entity comprises:
monitoring an interaction of the corresponding user with the target entity over the session; and,
estimating the feedback indicator according to the interaction.

3. The method of claim 1, wherein providing the feedback indicator on each target entity comprises:
setting the feedback indicator by the corresponding user, the feedback indicator maintaining a last setting thereof at each instant within the session; and,
prompting the user to set the feedback indicator in response to the expiration of a predefined time-out from the last setting.

4. The method of claim 3, wherein the information is logically organized into a plurality of topics, and providing the feedback indicator on each target entity comprises:
resetting the feedback indicator to a neutral value in response to a start of each topic.

5. The method of claim 1, further comprising:
entering a message on each target entity by the corresponding user;
transmitting the message from each target entity to the control entity; and,
forwarding the message from the control entity to the other client entities,
wherein returning the feedback indicator from each target entity to the control entity comprises:
inserting the feedback indicator into a service message to cause the transmission of the service message from the target entity to the control entity, the service message having a predefined format;
discriminating the service message from the other messages on the control entity according to the format to prevent the forwarding of the service message to the other client entities; and,
extracting the feedback information from the service message on the control entity.

6. The method of claim 1, wherein outputting at least partially the representation of the history comprises:
displaying the representation of a most recent portion of the history substantially in real-time for controlling the session according to the most recent portion of the history.

7. The method of claim 6, wherein outputting at least partially the representation of the history further comprises:
detecting a warning condition in response to the at least one aggregated indicator substantially passing a threshold value for a threshold period; and,
signaling the warning condition to the controller.

8. The method of claim 1, further comprising:
transmitting the at least one aggregated indicator from the control entity to each target entity; and,
further outputting at least partially the representation of the history on each target entity to the corresponding user.

9. The method of claim 1, wherein outputting at least partially the representation of the history comprises:
logging the history on the control entity; and,
retrieving the history off-line for controlling a next working session of the virtual meeting according to the history.

10. The method of claim 1, wherein the at least one source entity is a single source entity, the control entity including the source entity.

11. The method of claim 1, wherein the at least one source entity are a plurality of source entities for transmitting the information to each target entity by a corresponding presenter under the control of the control entity, the at least one aggregated indicator at each instant being associated with the corresponding presenter.

12. A computer-readable medium having a computer program stored thereon, the computer program when executed on a data processing system having a distributed architecture causing the data processing system to perform a method for delivering information in a virtual meeting on the data processing system, the method comprising:
transmitting information from at least one source entity of the system to a plurality of target entities of the system over a working session;
outputting the information on each target entity to a corresponding user;
providing a feedback indicator on each target entity, the feedback indicator being indicative of a personal level of interest of the corresponding user for the information at each instant within the session;
returning the feedback indicator from each target entity to a control entity of the system;
aggregating the feedback indicators on the control entity into at least one aggregated indicator, the aggregated indicator being indicative of an overall level of interest of the users for the information at each instant within the session; and,
outputting at least partially a representation of a history of the session of the at least one aggregated indicator on the control entity to a controller of the virtual meeting for controlling the virtual meeting according to the history.

13. The computer-readable medium of claim 12, wherein providing the feedback indicator on each target entity comprises:
monitoring an interaction of the corresponding user with the target entity over the session; and,
estimating the feedback indicator according to the interaction.

14. The computer-readable medium of claim 12, wherein providing the feedback indicator on each target entity comprises:
setting the feedback indicator by the corresponding user, the feedback indicator maintaining a last setting thereof at each instant within the session; and,
prompting the user to set the feedback indicator in response to the expiration of a predefined time-out from the last setting.

15. The computer-readable medium of claim 12, wherein the method further comprises:
entering a message on each target entity by the corresponding user;
transmitting the message from each target entity to the control entity; and,
forwarding the message from the control entity to the other client entities,
wherein returning the feedback indicator from each target entity to the control entity comprises:
inserting the feedback indicator into a service message to cause the transmission of the service message from the target entity to the control entity, the service message having a predefined format;
discriminating the service message from the other messages on the control entity according to the format to prevent the forwarding of the service message to the other client entities; and,
extracting the feedback information from the service message on the control entity.

16. The computer-readable medium of claim 12, wherein outputting at least partially the representation of the history comprises:
displaying the representation of a most recent portion of the history substantially in real-time for controlling the session according to the most recent portion of the history.

17. The computer-readable medium of claim 12, wherein the method further comprises:
transmitting the at least one aggregated indicator from the control entity to each target entity; and,
further outputting at least partially the representation of the history on each target entity to the corresponding user.

18. The computer-readable medium of claim 12, wherein outputting at least partially the representation of the history comprises:
logging the history on the control entity; and,
retrieving the history off-line for controlling a next working session of the virtual meeting according to the history.

19. A virtual meeting system for delivering information in a virtual meeting on a data processing system with distributed architecture, the virtual meeting system including:
a first interface to transmit information from at least one source computer of the system to a plurality of target computers of the system over a working session;
a first output driver to output the information on each target computer to a corresponding user;
an interest engine to provide a feedback indicator on each target computer, the feedback indicator being indicative of a personal level of interest of the corresponding user for the information at each instant within the session;
a second interface to return the feedback indicator from each target computer to a control computer of the system;
an evaluator to aggregate the feedback indicators on the control computer into at least one aggregated indicator, the aggregated indicator being indicative of an overall level of interest of the users for the information at each instant within the session; and,
a second output driver to output at least partially a representation of a history of the session of the at least one aggregated indicator on the control computer to a controller of the virtual meeting for controlling the virtual meeting according to the history.
